(19) United States
(12) Patent Application Publication
(10) Pub. No.: US 2015/0274015 A1
(43) Pub. Date: Oct. 1, 2015

(54) CONTROL ELEMENT FOR A MOTOR VEHICLE

(71) Applicant: AUDI AG, Ingolstadt (DE)

(72) Inventors: Michael Wachinger, Winkelhausen (DE); Johann Schneider, Wettstetten (DE); Marcus Kuhne, Inglostadt (DE)

(21) Appl. No.: 14/436,796

(22) PCT Filed: Oct. 17, 2013
(86) PCT No.: PCT/EP2013/003130

§ 371 Date: Apr. 17, 2015

(30) Foreign Application Priority Data
Oct. 19, 2012 (DE) 10 2012 020 609.7

(51) Int. Cl. B60K 35/00; G06F 1/16; G06F 3/041

(52) U.S. Cl. CPC B60K 35/00; G06F 3/041; G06F 1/16; G06F 2203/04103; B60K 2350/1004; B60K 2350/1028; B60K 2350/102

(57) ABSTRACT

The invention relates to a control element (10) for a motor vehicle, with an operating surface (14) for entering user instructions for a component of the motor vehicle, which comprises at least one surface structure element (20, 22) which can be felt by a user, wherein the operating surface (14) is formed from glass and the at least one surface structure element (20, 22) forms a single piece with the operating surface (14).

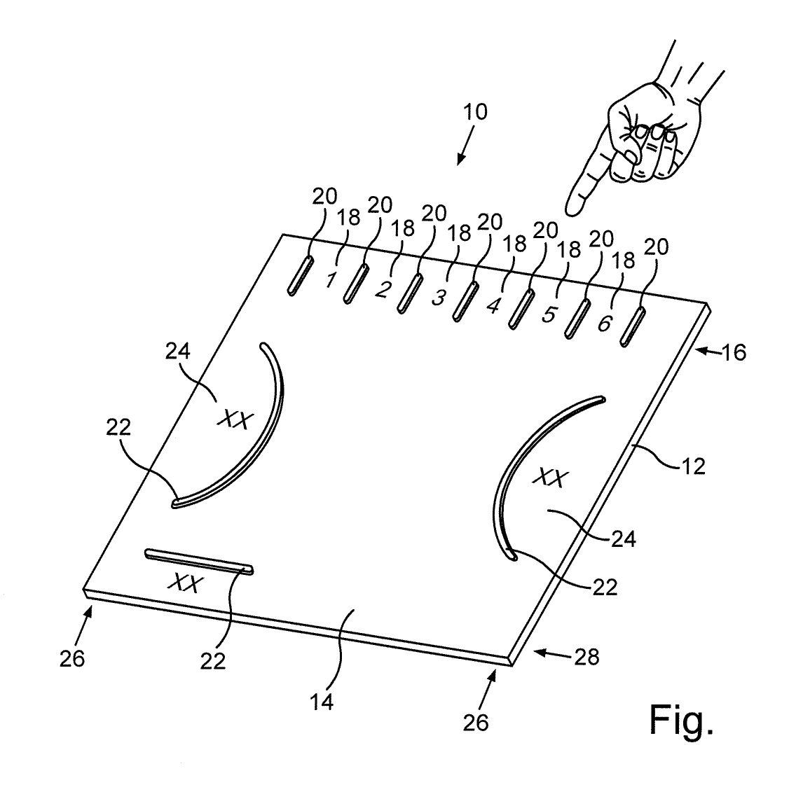

The invention relates to a control element for a motor vehicle according to the preamble of claim 1 as well as to a method for producing such a control element according to the preamble of claim 8.

Flat control elements such as touchscreens or touchpads, for example, are used increasingly for entering user instructions in motor vehicles, for example, for controlling navigation and entertainment systems and the like.

In such a control element, several areas are usually provided each of which, when touched, activate different functions. Depending on the operating state, the arrangement and functional allocation of these areas can change. However, during driving operation of the motor vehicle, it is not desirable for the user to avert his/her gaze from the road to be able to reliably use the control element.

DE 10 2010 042 690 A1 discloses that, on a ceramic surface of a touch-sensitive control element, haptic structures can be applied by mechanical machining such as lapping, sandblasting or the like, for example. Such structures allow the user to feel individual partial areas of the control element without having to avert his/her gaze from the road.

However, such mechanical machining can weaken the structural integrity of the operating surface, so that, in the case of mechanical stress, rupture can occur quickly which in turn requires expensive repair.

The present invention is therefore based on the problem of providing a control element according to the preamble of claim 1 as well as a method for the manufacture thereof according to the preamble of claim 8, which ensure a particularly good tolerance to mechanical stress.

Such a control element for a motor vehicle comprises an operating surface for entering user instructions for a component of the motor vehicle, which comprises at least one surface structure element that can be felt by a user.

According to the invention, it is provided here that the operating surface is formed from glass and the at least one surface structure element forms a single piece with the operating surface. In contrast to ceramic surfaces known from the prior art, in the case of glass, no mechanical processing and in particular no machining processing is required to produce such surface structure elements. In the production by primary forming or reforming, clearly lower material stresses are generated than in the case of machining processing, so that a clearly more durable, in particular scratch- and abrasion-resistant, control element is produced.

It is particularly advantageous here if the at least one surface structure element is formed by deep drawing of the operating surface in the heated state. In this way, surface structures of nearly any desired shape can thus be formed in a reliable process, and after the subsequent curing, they have the desired resistance to scratching and abrasion.

The control element itself can be designed here as a touchscreen or touchpad. Here the use of haptic surface structures is particularly advantageous, in order to prevent averting the attention of the driver from the road. Naturally, such structured operating surfaces can also be used for pressure switches, sliding switches, control dials or the like.

In another embodiment of the invention, a partial operating surface of the operating surface is delimited and/or marked by the at least one surface structure element. This makes it easier for the driver to find such partial operating surfaces based on haptic information alone.

Alternatively or additionally, the at least one surface structure element can also be used as a design element and improve the visual appearance of the control element.

In an additional embodiment of the invention, the operating surface is arched in at least one spatial direction. Such operating surfaces as well can be produced cost effectively and reliably by deep drawing and can be integrated in a manner that is particularly appealing visually in dashboards, center consoles or the like that are also arched.

The invention furthermore relates to a method for producing a control element of the above-described type. According to the invention, the at least one surface structure element is here produced by deep drawing of the operating surface in the heated state. Here too the aforementioned advantages apply.

Below, the invention and its embodiments are further explained based on the drawing. The single figure here shows an embodiment example of a control element according to the invention.

A control element, referred to as a whole as 10, for a motor vehicle comprises a plate 12 made of a glass, which forms the touch-sensitive surface 14 of a touchscreen or touchpad not represented further in detail.

In a first partial area 16 of the control element, a number of control panels 18 are provided, which can be allocated to different functions depending on the operating state, which, when touched, can actuate, for example, different aspects of a navigation system or entertainment system or also other functions of the motor vehicle.

In order to allow a purely haptic detection of the operating fields 18 by the driver, so that the latter does not have to avert his/her gaze from the road for the operation, the operating fields 18 are defined by respective surface structures 20 which are arranged on the side and raised above the surface 14. Additional surface structures 22 define additional operating areas 24 in the side areas 26 and in the lower area 28 of the control element 10.

In order to produce the surface structures 20, 22, the plate 12 is first provided in a planar state and heated above its softening temperature in an appropriate tool. The tool has two tool halves with complementary recesses and depressions which correspond to the surface structures 20, 22. By closing the tool halves, the plate in the softened state is then brought into the desired shape and cured again by cooling.

The surface structures 20, 22 can here be designed to be of nearly any desired height relative to the surface 14. In particular, different surface structures 20, 22 can also have different heights and different surface features such as, for example, fluting, notching, imagery or the like, in order to give the user of the control element 10 further haptic indications facilitating the operation for him/her. Here the surface structures 20, 22 do not have to be formed, as shown in the figure, in each case as areas raised above the surface 14, instead they can also be recessed relative to the surface 14.

In the horizontal extension of the surface structures 20, 22 as well, broader design leeway exists. Thus, simple bars, arcs or more complex geometric figures can be produced, which, in addition to providing haptic support to the user, can also have design functions and improve the visual appearance of the control element.

In addition, the entire surface 14 can be provided with pebbling. This facilitates the sliding of the user's finger over the surface 14 and prevents the formation of fingerprints.

In deep drawing, it is possible moreover to confer a curvature to the surface 14 or to the entire plate 12, so that it can be used in a visually pleasing manner in a dashboard that is also curved or the like.

Surface structures 20, 22 designed in this manner are suitable not only, as described, for the formation of touchscreens or touchpads; instead, they can also be applied to any other control elements 10 such as, for example, pressure switches, sliding switches, control dials or the like, which, as a result of the glass and ceramic surface, receive a particularly high-quality and durable form.

1. Control element (10) for a motor vehicle, with an operating surface (14) for entering user instructions for a component of the motor vehicle, which comprises at least one surface structure element (20, 22) which can be felt by a user,
characterized in that
the operating surface (14) is formed from glass and the at least one surface structure element (20, 22) forms a single piece with the operating surface (14).

2. Control element (10) according to claim 1,
characterized in that
at least one surface structure element (20, 22) is formed by deep drawing of the operating surface (14) in the heated state.

3. Control element (10) according to claim 1 or 2,
characterized in that
the control element (10) is a touchscreen or touchpad.

4. Control element (10) according to claim 1 or 2,
characterized in that
the control element (10) is a pressure switch, a sliding switch, a control dial or the like.

5. Control element (10) according to any one of claims 1 to 4,
characterized in that
the at least one surface structure element (20, 22) delimits and/or marks a partial operating surface (18) of the operating surface (14).

6. Control element (10) according to any one of claims 1 to 5,
characterized in that
at least one surface structure element (20, 22) is a design element.

7. Control element (10) according to any one of claims 1 to 6,
characterized in that
the operating surface (14) is arched in at least one spatial direction.

8. Method for producing a control element (10) according to any one of claims 1 to 7,
characterized in that
at least one surface structure element (20, 22) is formed by deep drawing of the operating surface (14) in the heated state.
